(19) United States
(12) Patent Application Publication
(10) Pub. No.: US 2025/0362495 A1
(43) Pub. Date: Nov. 27, 2025

(54) VIBRATION DEVICE

(71) Applicant: Murata Manufacturing Co., Ltd., Nagaokakyo-shi (JP)

(72) Inventors: Noritaka KISHI, Nagaokakyo-shi (JP); Yuuki ISHII, Nagaokakyo-shi (JP); Rei HIGASHIDA, Nagaokakyo-shi (JP); Hitoshi SAKAGUCHI, Nagaokakyo-shi (JP)

(21) Appl. No.: 19/289,376

(22) Filed: Aug. 4, 2025

Related U.S. Application Data
(63) Continuation of application No. PCT/JP2023/040072, filed on Nov. 7, 2023.

(30) Foreign Application Priority Data
Mar. 3, 2023 (JP) 2023-032840

(51) Int. Cl. G02B 27/00; B06B 1/06; B08B 7/02; B08B 13/00

(52) U.S. Cl. CPC G02B 27/0006; B06B 1/0651; B08B 7/02; B08B 13/00

(57) ABSTRACT

A vibration device that includes: an internal vibration body constructed to amplify vibration; a piezoelectric element connected to a first end of the internal vibration body in a first direction and constructed to generate vibration; a light transmissive body connected to a second end of the internal vibration body in the first direction and has an optical axis extending in the first direction; and an external vibration body including a first connection portion connected to the light transmissive body and an attenuator portion that extends in a second direction intersecting the first direction from the first connection portion toward an outside of the light transmissive body and constructed to attenuate vibration, wherein the attenuator portion has non-axisymmetry with respect to the optical axis.

### CROSS REFERENCE TO RELATED APPLICATIONS

The present application is a continuation of International application No. PCT/JP2023/040072, filed Nov. 7, 2023, which claims priority to Japanese Patent Application No. 2023-032840, filed Mar. 3, 2023, the entire contents of each of which are incorporated herein by reference.

### TECHNICAL FIELD

The present disclosure relates to a vibration device.

### BACKGROUND ART

Patent Document 1 discloses a vibration device including a non-equilibrium means that removes a mass of a portion or adds a mass to a portion of at least one of a light transmissive body, a first cylindrical body, a second cylindrical body, a spring portion, and a vibration body.
Patent Document 1: Japanese Patent No. 6819846

### SUMMARY OF THE DISCLOSURE

In the vibration device of Patent Document 1, there is room for improvement in terms of removal of foreign matter adhering to the light transmissive body.

The present disclosure intends to provide a vibration device that can remove foreign matter adhering to a light transmissive body.

A vibration device of an aspect of the present disclosure includes: an internal vibration body constructed to amplify vibration; a piezoelectric element connected to a first end of the internal vibration body in a first direction and constructed to generate vibration; a light transmissive body connected to a second end of the internal vibration body in the first direction and has an optical axis extending in the first direction; and an external vibration body including a first connection portion connected to the light transmissive body and an attenuator portion that extends in a second direction intersecting the first direction from the first connection portion toward an outside of the light transmissive body and constructed to attenuate vibration, wherein the attenuator portion has non-axisymmetry with respect to the optical axis.

According to the present disclosure, a vibration device that can remove foreign matter adhering to the light transmissive body can be provided.

### BRIEF DESCRIPTION OF THE DRAWINGS

FIG. 1 is a perspective view depicting a vibration device of an embodiment of the present disclosure.

FIG. 2 is a sectional view along line II-II in FIG. 1.

FIG. 3 is a perspective view depicting the vibration device of FIG. 1 as viewed in a different direction from FIG. 1.

FIG. 4 is a graph depicting a relationship between impedance and frequency.

FIG. 5 is a sectional view depicting a first modification of the vibration device of FIG. 1.

FIG. 6 is a perspective view depicting a second modification of the vibration device of FIG. 1.

FIG. 7 is a sectional view depicting a third modification of the vibration device of FIG. 1.

FIG. 8 is a sectional view depicting a fourth modification of the vibration device of FIG. 1.

FIG. 9 is a perspective view depicting a fifth modification of the vibration device of FIG. 1.

FIG. 10 is a bottom view of the vibration device of FIG. 9.

FIG. 11 is a sectional view depicting a sixth modification of the vibration device of FIG. 1.

FIG. 12 is a sectional view depicting a seventh modification of the vibration device of FIG. 1.

FIG. 13 is a perspective view depicting an example of a wiring line of the vibration device of FIG. 12.

FIG. 14 is a perspective view depicting a first example of the wiring line of FIG. 13.

FIG. 15 is a perspective view depicting a second example of the wiring line of FIG. 13.

### DESCRIPTION OF THE PREFERRED EMBODIMENTS

Various aspects of the present disclosure are described.

A vibration device of a first aspect of the present disclosure includes: an internal vibration body constructed to amplify vibration; a piezoelectric element connected to a first end of the internal vibration body in a first direction and constructed to generate vibration; a light transmissive body connected to a second end of the internal vibration body in the first direction and has an optical axis extending in the first direction; and an external vibration body including a first connection portion connected to the light transmissive body and an attenuator portion that extends in a second direction intersecting the first direction from the first connection portion toward an outside of the light transmissive body and constructed to attenuate vibration, wherein the attenuator portion has non-axisymmetry with respect to the optical axis.

In the vibration device of the first aspect, because the attenuator portion has the non-axisymmetry, an inclination can be given to the amplitude of vibration in the light transmissive body, and imbalance in the stress applied to the internal vibration body at the time of vibration can be reduced.

In the vibration device of a second aspect of the present disclosure, in the first aspect, the attenuator portion has a first attenuator portion and a second attenuator portion located symmetrically with respect to the optical axis in a sectional view along the optical axis, and a dimension of the first attenuator portion in the first direction is different from a dimension of the second attenuator portion in the first direction.

In the vibration device of the second aspect, the appearance of the vibration device can be made symmetric.

In the vibration device of a third aspect of the present disclosure, in the first aspect, the attenuator portion has a first attenuator portion and a second attenuator portion located symmetrically with respect to the optical axis in a sectional view along the optical axis, and a dimension of the first attenuator portion in the second direction is different from a dimension of the second attenuator portion in the second direction.

In the vibration device of the third aspect, the thickness of the attenuator portion as the dimension in the first direction can be made constant, and thus processing of the external vibration body by cutting, pressing, or the like becomes easier.

In the vibration device of a fourth aspect of the present disclosure, the first aspect, the attenuator portion has a first attenuator portion and a second attenuator portion located symmetrically with respect to the optical axis in a sectional view along the optical axis, and a material forming the first attenuator portion is different from a material forming the second attenuator portion.

In the vibration device of the fourth aspect, the appearance of the vibration device can be made symmetric.

In the vibration device of a fifth aspect of the present disclosure, any of the second to fourth aspects, the first attenuator portion is located on an upper side in a vertical direction relative to the second attenuator portion.

In the vibration device of the fifth aspect, foreign matter can be removed more reliably.

In the vibration device of a sixth aspect of the present disclosure, in any of the first to fifth aspects, the internal vibration body is located symmetrically with respect to the optical axis.

In the vibration device of the sixth aspect, imbalance in the stress applied to the internal vibration body at the time of vibration can be reduced more reliably, and unnecessary vibration attributed to non-axisymmetry can be suppressed.

In the vibration device of a seventh aspect of the present disclosure, in any of the first to sixth aspects, the piezoelectric element is located symmetrically with respect to the optical axis.

In the vibration device of the seventh aspect, imbalance in the stress applied to the internal vibration body at the time of vibration can be reduced more reliably, and unnecessary vibration attributed to non-axisymmetry can be suppressed.

In the vibration device of an eighth aspect of the present disclosure, in any of the second to fourth aspects, a wiring line is connected to the piezoelectric element from a position closer to the first attenuator portion than to the second attenuator portion.

In the vibration device of the eighth aspect, disconnection of the wiring line and sounding due to vibration of the wiring line can be suppressed.

In the vibration device of a ninth aspect of the present disclosure, in the eighth aspect, the wiring line includes a shield portion capable of suppressing electromagnetic noise.

In the vibration device of the ninth aspect, an electromagnetic shield effect for an imaging element can be enhanced at low cost without adding another component for shielding.

In the vibration device of a tenth aspect of the present disclosure, in the ninth aspect, the wiring line includes at least two electrically-conductive portions electrically independent of each other.

In the vibration device of the tenth aspect, a drive signal can be supplied to the piezoelectric element.

In the vibration device of an eleventh aspect of the present disclosure, in the tenth aspect, the at least two electrically-conductive portions have a first electrically-conductive portion connected to the piezoelectric element in such a manner as to be capable of transmitting a signal to the piezoelectric element and a second electrically-conductive portion with a potential fixed at a certain potential, and the second electrically-conductive portion has the same potential as the shield portion.

In the vibration device of the eleventh aspect, the potential can be supplied to the piezoelectric element.

The vibration device of a twelfth aspect of the present disclosure, in the eleventh aspect, further includes: an imaging element located on the optical axis inside the internal vibration body, the wiring line includes a plurality of layers, and the shield portion forms one of the plurality of layers and is located closer to the imaging element than the first electrically-conductive portion and the second electrically-conductive portion.

In the vibration device of the twelfth aspect, entry of noise into an imaging element circuit can be suppressed more reliably.

In the vibration device of a thirteenth aspect of the present disclosure, in the eleventh aspect or the twelfth aspect, the first electrically-conductive portion and the second electrically-conductive portion are wired by twisted wiring.

In the vibration device of the thirteenth aspect, electromagnetic noise can be suppressed more reliably.

In the vibration device of a fourteenth aspect of the present disclosure, in any of the first to thirteenth aspects, the attenuator portion includes: a second connection portion that extends in the second direction from the first connection portion toward the outside of the light transmissive body, and a non-axisymmetric portion that is located closer to the light transmissive body than the second connection portion in the first direction and is connected to the second connection portion, the non-axisymmetric portion having non-axisymmetry with respect to the optical axis.

In the vibration device of the fourteenth aspect, the non-axisymmetry of the attenuator portion can be easily obtained.

A vibration device of a fifteenth aspect of the present disclosure includes: a vibration body constructed to amplify vibration; a piezoelectric element connected to a first end of the vibration body in a first direction and constructed to generate vibration; a light transmissive body connected to a second end of the vibration body in the first direction and has an optical axis extending in the first direction; and an attenuator portion that is located at an edge portion of the light transmissive body in a second direction intersecting the first direction and connects the vibration body to the light transmissive body, the attenuator portion constructed to attenuate vibration, wherein the attenuator portion has non-axisymmetry with respect to the optical axis.

In the vibration device of the fifteenth aspect, both confinement of the vibration and the non-axisymmetry of the attenuator portion can be achieved.

An embodiment of the present disclosure is described below in accordance with the accompanying drawings. The following description is essentially merely an example, and does not intend to limit the present disclosure, the application of the present disclosure, or the use of the present disclosure. The drawings are schematic ones, and dimensional ratios and the like of each diagram depicted in the drawings do not necessarily correspond with actual ones.

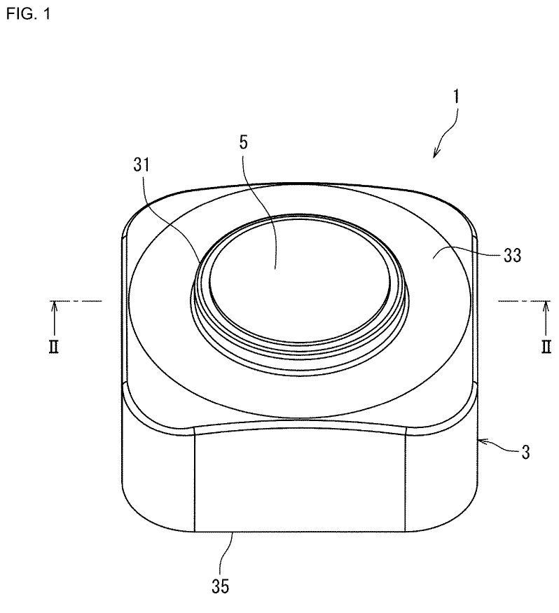

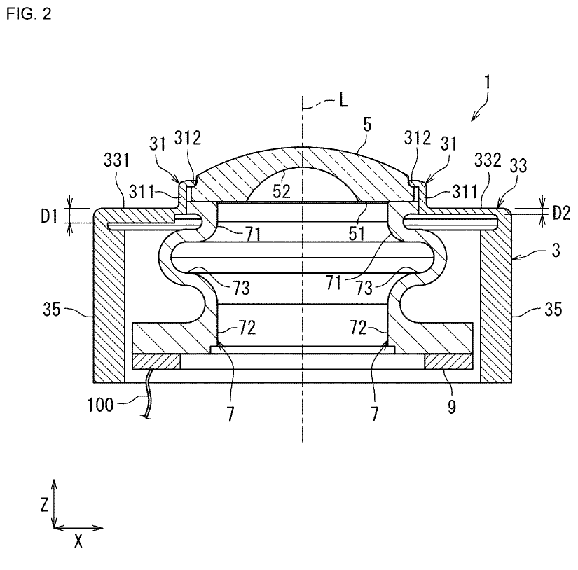

As depicted in FIGS. 1 and 2, a vibration device 1 includes an internal vibration body 7, a piezoelectric element 9, a lens (an example of the light transmissive body) 5, and an external vibration body 3. The piezoelectric element 9 is connected to one end of the internal vibration body 7 in a first direction (for example, Z-direction). The lens 5 is connected to the other end of the internal vibration body 7 in the first direction Z. The lens 5 has an optical axis L extending in the first direction Z. Vibration generated by the piezoelectric element 9 is transmitted to the lens 5 through the internal vibration body 7, and the lens 5 vibrates. This removes foreign matter such as water droplets or mud adhering to the lens 5.

The internal vibration body 7 is configured to be capable of amplifying the vibration generated by the piezoelectric element 9. The internal vibration body 7 is composed of, for example, a metal material, ceramics, or the like. Examples of the metal material forming the internal vibration body 7 include stainless steel, aluminum, iron, titanium, and duralumin. Surface treatment such as oxidation treatment or alumite treatment may be performed on a surface of the internal vibration body 7 in order to enhance the adhesiveness of an adhesive. For example, by coloring a surface of the internal vibration body 7 black by surface treatment, the lowering of optical performance due to diffuse reflection of light can be prevented.

In the present embodiment, the internal vibration body 7 is a cylindrical body as an example, and is located symmetrically with respect to the optical axis L. The internal vibration body 7 includes a first portion 71 in contact with the lens 5, a second portion 72 to which the piezoelectric element 9 is attached, and a third portion 73 that connects the first portion 71 to the second portion 72. The first portion 71 and the second portion 72 have a circular cylindrical shape extending in the first direction Z. The second portion 72 is configured to vibrate along with the vibration of the piezoelectric element 9, and has a large plate thickness (that is, dimension in the first direction Z) compared with the first portion 71 and the third portion 73. This facilitates more efficient transmission of the vibration of the piezoelectric element 9 to the lens 5. The third portion 73 has a substantially S-shape as a sectional shape. The third portion 73 is configured to support the first portion 71 and transmit the vibration of the second portion 72 to the first portion 71.

The first portion 71, the second portion 72, and the third portion 73 may be monolithically formed or may be individually formed. The maximum external dimension (that is, the maximum dimension in a second direction (for example, X-direction) intersecting the first direction Z) of the third portion 73 is larger than that of the first portion 71, and the maximum external dimension of the second portion 72 is larger than that of the third portion 73. This can efficiently transmit the vibration of the piezoelectric element 9 to the lens 5.

The external vibration body 3 is configured to prevent the vibration of the internal vibration body 7 from escaping to a component other than the lens 5 to allow efficient transmission of the vibration to the lens 5. As an example, the external vibration body 3 is configured to be capable of covering the whole of the internal vibration body 7 and protecting the internal vibration body 7 from the outside. The external vibration body 3 is composed of, for example, a metal material such as stainless steel, aluminum, iron, titanium, or duralumin, or a resin.

The external vibration body 3 has a substantially quadrangular prism shape as an example, and includes a first connection portion 31, an attenuator portion 33, and a fixing portion 35.

As depicted in FIG. 2, the first connection portion 31 extends in the first direction Z and a direction away from the piezoelectric element 9 from an end closer to the internal vibration body 7 in the second direction X in the attenuator portion 33. In the present embodiment, the first connection portion 31 includes a plate-shaped portion 311 and a protrusion 312. The plate-shaped portion 311 extends in the first direction Z from the attenuator portion 33. The protrusion 312 is located at an end portion remoter from the attenuator portion 33 in the first direction Z in the plate-shaped portion 311. The protrusion 312 protrudes from the plate-shaped portion 311 in the second direction X and toward the lens 5. An edge portion of the lens 5 is interposed between the protrusion 312 and the first portion 71 of the internal vibration body 7.

The attenuator portion 33 extends in the second direction X from the first connection portion 31 toward the outside of the lens 5 and is configured to attenuate the vibration generated by the piezoelectric element 9. The attenuator portion 33 has a smaller thickness and a thinner wall thickness than the fixing portion 35, and thus has spring characteristics.

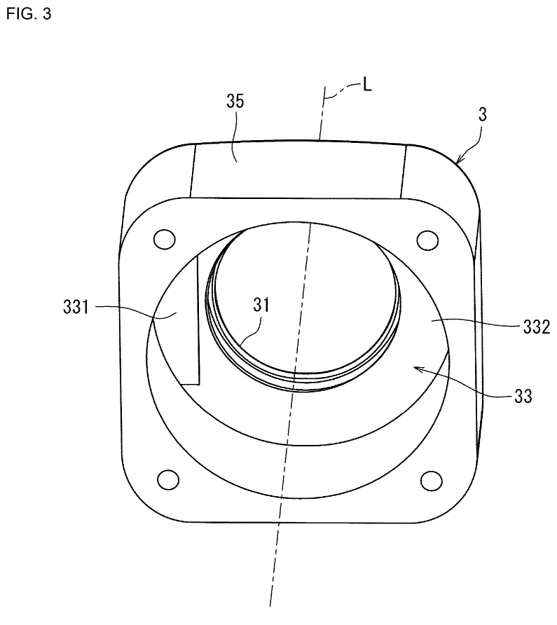

The attenuator portion 33 has non-axisymmetry with respect to the optical axis L. In the present embodiment, as depicted in FIGS. 2 and 3, the attenuator portion 33 includes a first attenuator portion 331 and a second attenuator portion 332 located symmetrically with respect to the optical axis L in sectional view along the optical axis L. A dimension D1 of the first attenuator portion 331 in the first direction Z (that is, thickness dimension) is different from a dimension D2 of the second attenuator portion 332 in the first direction Z.

As an example, the vibration device 1 depicted in FIGS. 1 to 3 is configured such that the thickness dimension D1 of the first attenuator portion 331 is larger than the thickness dimension D2 of the second attenuator portion 332. Specifically, the surface on the side of the lens 5 in the first direction Z in the first attenuator portion 331 and the surface on the side of the lens 5 in the first direction Z in the second attenuator portion 332 are located on substantially the same plane. Meanwhile, the surface on the side of the piezoelectric element 9 in the first direction Z in the first attenuator portion 331 is located closer to the piezoelectric element 9 than the surface on the side of the piezoelectric element 9 in the first direction Z in the second attenuator portion 332.

In this case, the amplitude of the vibration generated by the piezoelectric element 9 is smaller in the first attenuator portion 331 than in the second attenuator portion 332. For example, slip-off of foreign matter from the lens 5 can be promoted by disposing the vibration device 1 such that the first attenuator portion 331 is located on the upper side in the vertical direction relative to the second attenuator portion 332.

In the present embodiment, as depicted in FIG. 2, a wiring line 100 is connected to the piezoelectric element 9 from a position closer to the first attenuator portion 331 than to the second attenuator portion 332, and a voltage is applied to the piezoelectric element 9 through the wiring line 100. By connecting the wiring line 100 from the side of the first attenuator portion 331, in which the amplitude is smaller, in this manner, disconnection of the wiring line 100 and sounding due to vibration of the wiring line 100 can be suppressed.

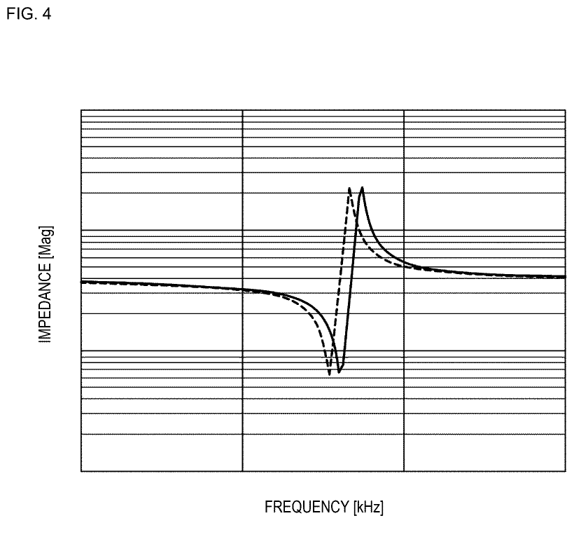

FIG. 4 depicts a relationship between the impedance and the frequency of the vibration device 1 having the non-axisymmetry and a relationship between the impedance and the frequency of a vibration device having axisymmetry. In FIG. 4, the relationship between the impedance and the frequency of the vibration device 1 is indicated by a solid line, and the relationship between the impedance and the frequency of the vibration device having the axisymmetry is indicated by a dotted line. The vibration device having the axisymmetry has the same configuration as the vibration device 1 except that the thickness dimension D1 of the first attenuator portion 331 is the same as the thickness dimension D2 of the second attenuator portion 332. As depicted in FIG. 4, in the vibration device 1, the minimum value of the impedance (=resonance resistance value) is small and loss caused by resistance is small compared with the vibration device having the axisymmetry. That is, in the vibration device 1, the amplitude in the lens 5 at the time of vibration can be inclined without increasing the resonance resistance value of the internal vibration body 7. The expression that “the amplitude in the lens 5 is inclined” means that a region in which the lens 5 vibrates with large amplitude and a region in which the lens 5 vibrates with small amplitude are formed in the surface of the lens 5.

The fixing portion 35 is configured to include a node that suppresses vibration to vibration with a displacement amount equal to or smaller than 1/100 of that of the lens 5 and be capable of suppressing vibration propagated to components (for example, a case that houses an imaging element and a lens module) connected to the fixing portion 35.

The vibration of the fixing portion 35 can be more suppressed when the volume of the fixing portion 35 is larger. However, in a case of reducing the size of the vibration device 1, it is difficult to simply increase the volume of the fixing portion 35. The fixing portion 35 of the present embodiment has a substantially rectangular outer shape. Employing this configuration can increase the volume of the fixing portion 35 without increasing the size of the vibration device 1. For example, the volume of a circular column shape with a diameter of 25 mm is larger than that of a rectangular parallelepiped with 25 mm×25 mm. The external vibration body 3 is composed of a material having a lower Young's modulus than the internal vibration body 7. Employing this configuration can increase the degree of attenuation of vibration by the attenuator portion 33.

The lens 5 is composed of, for example, glass. The upper surface of the lens 5 has a convex shape. As an example, the surface is coated with a water-repellent coat and an antireflection film (AR coat). The surface of the lens 5 on the optical imaging plane side is composed of a flat surface portion 51 and a concave portion 52. The flat surface portion 51 is connected to the first portion 71 of the internal vibration body 7 by, for example, an adhesive.

The piezoelectric element 9 has a piezoelectric body and electrodes, and is configured to be capable of generating vibration. The piezoelectric body is composed of, for example, appropriate piezoelectric ceramics such as barium titanate (BaTiO₃), lead zirconate titanate (PZT: PbTiO₃·PbZrO₃), lead titanate (PbTiO₃), lead metaniobate (PbNb₂O₆), bismuth titanate (Bi₄Ti₃O₁₂), or (K,Na)NbO₃ or an appropriate piezoelectric single crystal of LiTaO₃, LiNbO₃, or the like. The electrodes are composed of, for example, Ni, Ag, or Au.

In the present embodiment, the piezoelectric element 9 has an annular shape as viewed in the first direction Z, and is located symmetrically with respect to the optical axis L. The piezoelectric element 9 is connected to the second portion 72 of the internal vibration body 7 by, for example, an adhesive.

The adhesive between the lens 5 and the internal vibration body 7 and the adhesive between the piezoelectric element 9 and the internal vibration body 7 are composed of, for example, an epoxy resin. Using the adhesive with a high Young's modulus can reduce transmission loss of vibration between the two components.

The vibration device 1 can provide the following effects.

The vibration device 1 includes the internal vibration body 7 that can amplify vibration, the piezoelectric element 9 that is connected to one end of the internal vibration body 7 in the first direction Z and can generate vibration, the lens 5 that is connected to the other end of the internal vibration body 7 in the first direction Z and has the optical axis L extending in the first direction Z, and the external vibration body 3. The external vibration body 3 includes the first connection portion 31 connected to the lens 5 and the attenuator portion 33 that extends in the second direction X from the first connection portion 31 toward the outside of the lens 5 and attenuates vibration. The attenuator portion 33 has non-axisymmetry with respect to the optical axis L. This configuration can give an inclination to the amplitude in the lens 5 at the time of vibration and reduce imbalance in the stress applied to the internal vibration body 7 at the time of vibration.

The attenuator portion 33 has the first attenuator portion 331 and the second attenuator portion 332 located symmetrically with respect to the optical axis L in sectional view along the optical axis L. The dimension D1 of the first attenuator portion 331 in the first direction Z is different from the dimension D2 of the second attenuator portion 332 in the first direction Z. This configuration can make the appearance of the vibration device 1 symmetric.

The internal vibration body 7 is located symmetrically with respect to the optical axis L. This configuration can more reliably reduce imbalance in the stress applied to the internal vibration body 7 at the time of vibration, and suppress unnecessary vibration attributed to non-axisymmetry.

The piezoelectric element 9 is located symmetrically with respect to the optical axis L. This configuration can more reliably reduce imbalance in the stress applied to the internal vibration body 7 at the time of vibration, and suppress unnecessary vibration attributed to non-axisymmetry.

The vibration device 1 can be configured as follows.

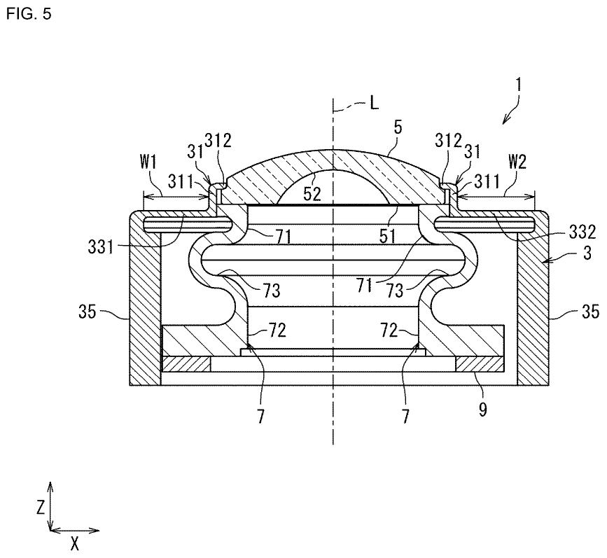

The non-axisymmetry of the attenuator portion 33 is not limited to the case in which the thickness dimension D1 of the first attenuator portion 331 is made different from the thickness dimension D2 of the second attenuator portion 332. For example, the non-axisymmetry may be given to the attenuator portion 33 by configurations depicted in FIGS. 5 to 11.

In the vibration device 1 depicted in FIG. 5, a dimension W1 of the first attenuator portion 331 in the second direction X is different from a dimension W2 of the second attenuator portion 332 in the second direction X. In the vibration device 1 depicted in FIG. 5, as an example, the dimension W2 of the second attenuator portion 332 is larger than the dimension W1 of the first attenuator portion 331. By employing this configuration, the thickness of the attenuator portion 33 as the dimension in the first direction can be made constant, and thus processing of the external vibration body 3 becomes easier. Also in this case, the amplitude of vibration generated by the piezoelectric element 9 is smaller in the first attenuator portion 331 than in the second attenuator portion 332.

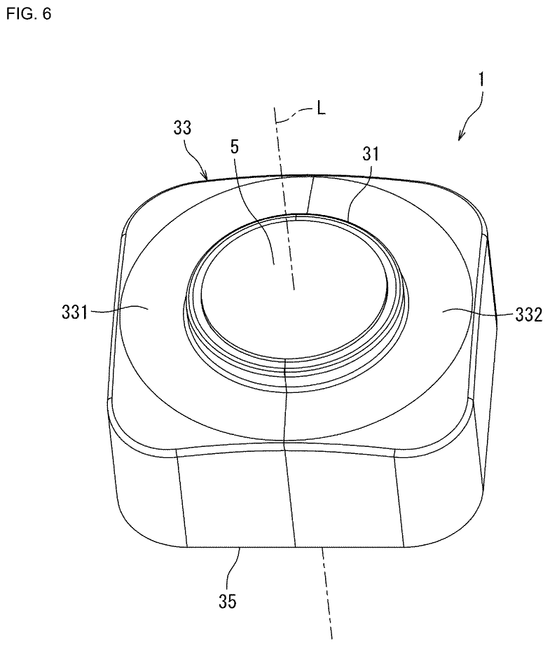

In the vibration device 1 depicted in FIG. 6, the material forming the first attenuator portion 331 is different from the material forming the second attenuator portion 332. In the vibration device 1 depicted in FIG. 6, as an example, the first attenuator portion 331 is composed of a material with a higher Young's modulus than the material of the second attenuator portion 332. Employing this configuration can make the appearance of the vibration device 1 symmetric. Also in this case, the amplitude of vibration generated by the piezoelectric element 9 is smaller in the first attenuator portion 331 than in the second attenuator portion 332. The non-axisymmetry of the attenuator portion 33 is not limited to the case in which the Young's modulus is made different between the first attenuator portion 331 and the second attenuator portion 332. For example, the density or the mechanical Q value may be made different therebetween.

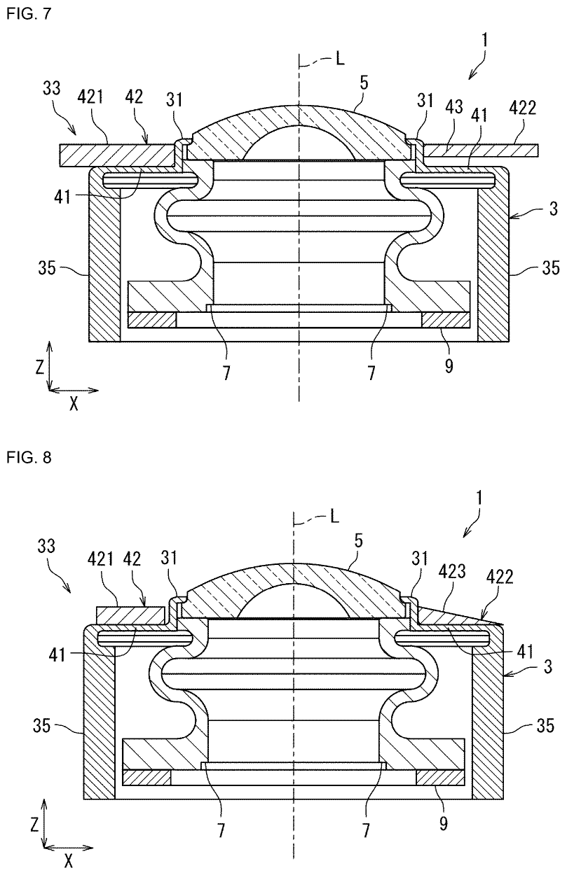

In the vibration devices 1 depicted in FIGS. 7 and 8, the attenuator portion 33 includes a second connection portion 41 and a non-axisymmetric portion 42. The second connection portion 41 extends in the second direction X from the first connection portion 31 toward the outside of the lens 5, and is formed monolithically with the first connection portion 31 and the fixing portion 35. The non-axisymmetric portion 42 has non-axisymmetry with respect to the optical axis L, and is located closer to the lens 5 than the second connection portion 41 in the first direction Z. The non-axisymmetric portion 42 is formed of, for example, a cover component that covers the outer surface of the second connection portion 41. The non-axisymmetric portion 42 connected to the second connection portion 41, with an adhesive or the like interposed therebetween, has a first attenuator portion 421 and a second attenuator portion 422 located symmetrically with respect to the optical axis L in sectional view along the optical axis L.

In the vibration device 1 depicted in FIG. 7, the first attenuator portion 421 is in contact with the second connection portion 41 and pressurizes the second connection portion 41. In contrast, the second attenuator portion 422 is not in contact with the second connection portion 41, and a gap 43 is formed between the second attenuator portion 422 and the second connection portion 41. That is, in the vibration device 1 depicted in FIG. 7, the amount of pressurization to the second connection portion 41 by the non-axisymmetric portion 42 is asymmetric with respect to the optical axis L.

In the vibration device 1 depicted in FIG. 8, both the first attenuator portion 421 and the second attenuator portion 422 are in contact with the second connection portion 41. However, the thickness dimension is different between the first attenuator portion 421 and the second attenuator portion 422. Specifically, the first attenuator portion 421 has a substantially rectangular section, and the second attenuator portion 422 has an inclined surface 423 that inclines toward the second connection portion 41 in the first direction Z away from the first connection portion 31 in the second direction X. Employing this configuration can prevent a liquid from accumulating on the surface of the attenuator portion 33.

The non-axisymmetry of the non-axisymmetric portion 42 is not limited to the examples depicted in FIGS. 7 and 8. For example, the non-axisymmetry of the non-axisymmetric portion 42 may be given by making the thicknesses different between the first attenuator portion 421 and the second attenuator portion 422 in a state in which both the first attenuator portion 421 and the second attenuator portion 422 have a substantially rectangular section. The non-axisymmetry of the non-axisymmetric portion 42 may be given by making the material different between the first attenuator portion 421 and the second attenuator portion 422.

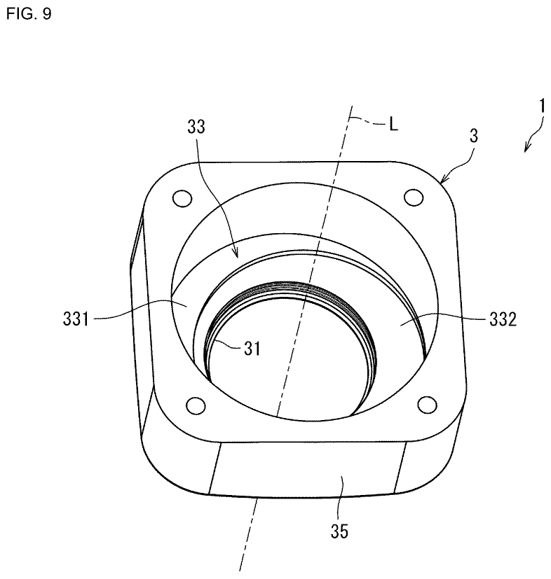

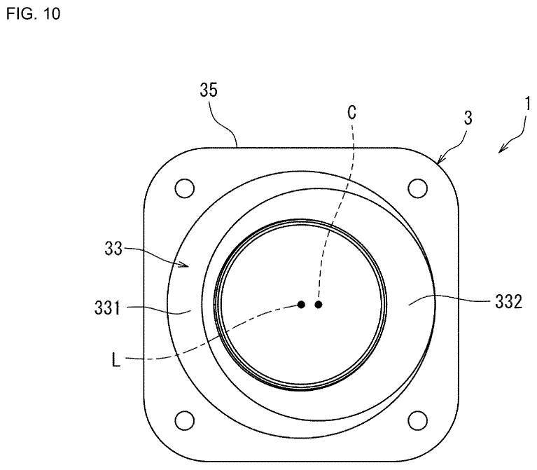

In the vibration device 1 depicted in FIGS. 9 and 10, as viewed in the first direction Z, the inner surface of the external vibration body 3 has a substantially circular shape, and the second attenuator portion 332 has a substantially circular shape. The center of the inner surface of the external vibration body 3 substantially corresponds with the optical axis L. A center point C of the second attenuator portion 332 does not correspond with the optical axis L, and is located at a position different from the optical axis L. The length ratio between the first attenuator portion 331 and the second attenuator portion 332 can be adjusted by changing the radial dimension of the second attenuator portion 332 and the position of the center point C. The second attenuator portion 332 can be processed by, for example, cutting using a lathe. That is, the attenuator portion 33 that is asymmetric can be formed also by general processing means such as the lathe.

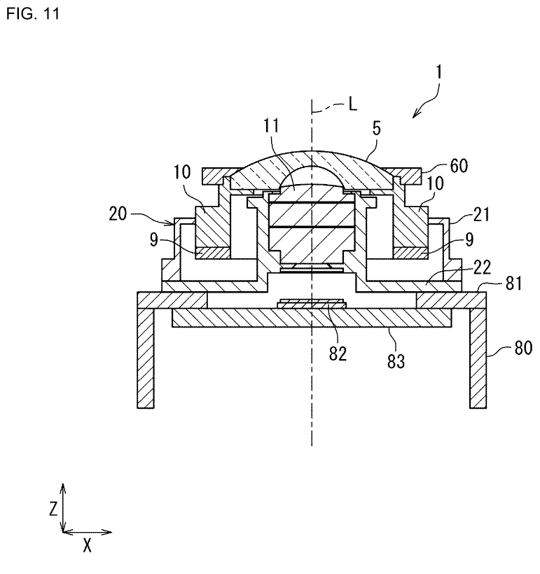

The vibration device 1 depicted in FIG. 11 includes the piezoelectric element 9 that can generate vibration, a vibration body 10, the lens 5, and an attenuator portion 60 configured to attenuate vibration. The vibration body 10 is configured to be capable of amplifying vibration. The piezoelectric element 9 is connected to one end of the vibration body 10 in the first direction Z. The lens 5 is connected to the other end of the vibration body 10 in the first direction Z. The vibration body 10 is bonded to the piezoelectric element 9 and the lens 5 by, for example, an adhesive.

The vibration device 1 depicted in FIG. 11 includes a casing 80 and an imaging portion 82. The casing 80 has a cylindrical shape having an opening end 81, and has a substrate 83 located at the opening end 81. The imaging portion 82 includes an imaging element, and is fixed to the substrate 83. A vibration structure 20 including the lens 5, the vibration body 10, and an inner layer lens 11 is fixed to the opening end 81 of the casing 80. The vibration structure 20 has a fixing portion 21 and an inner layer lens barrel 22. The fixing portion 21 fixes the lens 5 and the vibration body 10 to the inner layer lens barrel 22. The inner layer lens barrel 22 is configured to hold the inner layer lens 11, and is fixed to the opening end 81 of the casing 80.

The attenuator portion 60 is located at an edge portion of the lens 5 in the second direction X, and connects the vibration body 10 to the lens 5. For example, the attenuator portion 60 is formed of a component separate from the vibration body 10, and is screwed to the vibration body 10. This causes the edge portion of the lens 5 to be held by the attenuator portion 60 and the vibration body 10, and prevents the lens 5 from dropping off. Due to this configuration, the vibration body 10 closer to a node of vibration than the lens 5 can be fixed by the fixing portion 21, and thus it is possible to achieve both confinement of the vibration and non-axisymmetry of the attenuator portion 60.

The non-axisymmetry of the attenuator portion 33 may be given by combining any configurations among the configurations depicted in FIGS. 1 to 11.

The first attenuator portion 331 or 421 and the second attenuator portion 332 or 422 are only required to be configured to be located asymmetrically with respect to the optical axis L in at least one sectional view along the optical axis L.

When the amplitude of vibration generated by the piezoelectric element 9 is larger in the second attenuator portion 332 or 422 than in the first attenuator portion 331 or 421, the first attenuator portion 331 or 421 may be, but is not required to be, located on the upper side in the vertical direction relative to the second attenuator portion 332 or 422.

The internal vibration body 7 and the piezoelectric element 9 may be, but is not required to be, located symmetrically with respect to the optical axis L.

When the amplitude of vibration generated by the piezoelectric element 9 is larger in the second attenuator portion 332 or 422 than in the first attenuator portion 331 or 421, the wiring line 100 may be, but is not required to be, connected to the piezoelectric element 9 from a position closer to the first attenuator portion 331 or 421 than to the second attenuator portion 332 or 422.

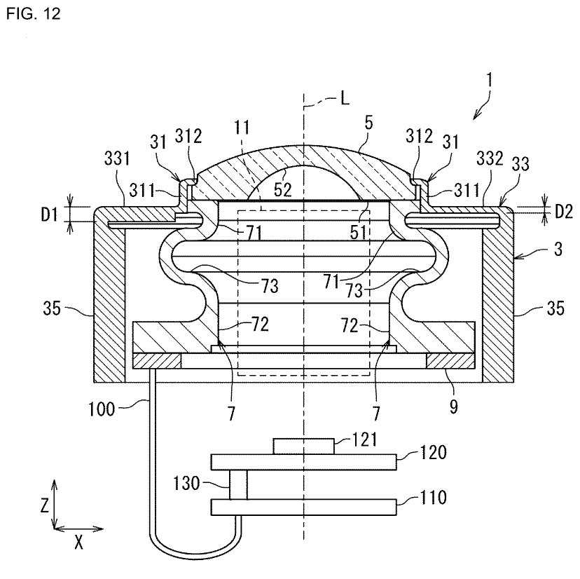

With reference to FIGS. 12 to 15, an example of the wiring line 100 connected to the piezoelectric element 9 is described.

In the vibration device 1 depicted in FIG. 12, the wiring line 100 is connected to the piezoelectric element 9 and a drive circuit 110. The drive circuit 110 is connected to an imaging element board 120 by a board-to-board connector 130. An imaging element 121 is mounted on the imaging element board 120. The imaging element 121 is located on the optical axis L inside the internal vibration body 7. The inner layer lens 11 is located between the lens 5 and the imaging element 121 in the first direction Z.

The wiring line 100 includes a shield portion 101 and two electrically-conductive portions electrically independent of each other. By this wiring line 100, an electromagnetic shield effect for the imaging element 121 can be enhanced at low cost without adding another component for shielding. Further, a drive signal can be supplied to the piezoelectric element 9 by the two electrically-conductive portions.

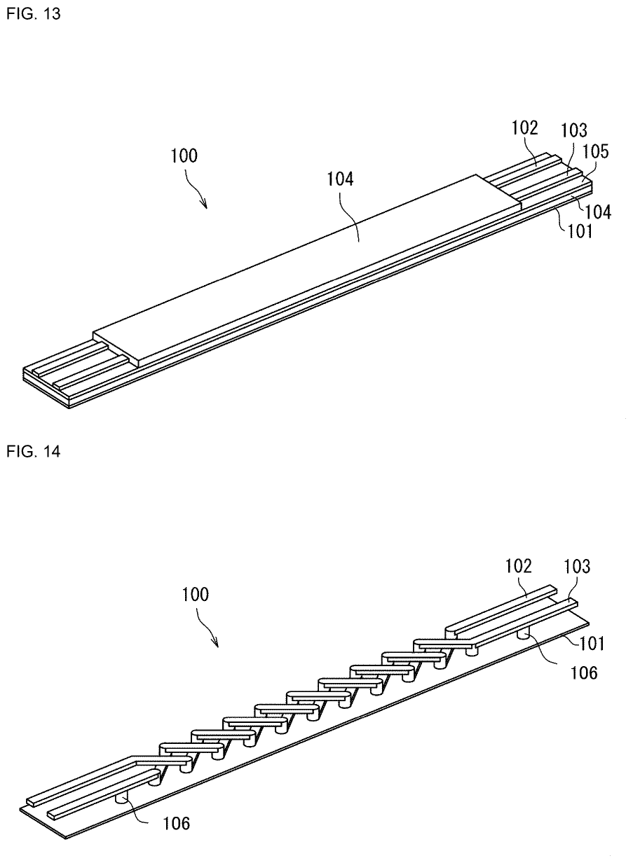

For example, the wiring line 100 is a flexible substrate including a plurality of layers, and each of the shield portion 101 and the two electrically-conductive portions forms one of the plurality of layers. As an example, in the wiring line 100, as depicted in FIG. 13, layers are laminated in order of the shield portion 101, a protective layer 104, a base film 105, the two electrically-conductive portions, and the protective layer 104. The protective layer 104 and the base film 105 are formed of, for example, polyimide (PI) or a PET film.

The shield portion 101 is configured to be capable of suppressing electromagnetic noise. By making a configuration such that the shield portion 101 is located closest to the imaging element 121 among the plurality of layers, entry of electromagnetic noise into a circuit of the imaging element 121 can be suppressed more reliably. The shield portion 101 is formed of, for example, a copper foil, Permalloy, or iron.

The two electrically-conductive portions (hereinafter, referred to as first electrically-conductive portion 102 and second electrically-conductive portion 103) are electrically independent of each other (in other words, are not electrically short-circuited). The first electrically-conductive portion 102 and the second electrically-conductive portion 103 are formed of, for example, a copper foil, and are located between the base film 105 and the protective layer 104. The first electrically-conductive portion 102 is connected to the piezoelectric element 9 in such a manner as to be capable of transmitting a signal to the piezoelectric element 9. The second electrically-conductive portion 103 has the same potential as the shield portion 101. The potential of the second electrically-conductive portion 103 is fixed at a certain value including the ground. This can supply the potential to the piezoelectric element 9.

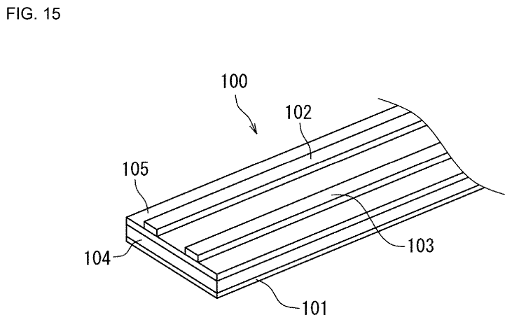

Examples of the wiring form of the first electrically-conductive portion 102 and the second electrically-conductive portion 103 are depicted in FIGS. 14 and 15.

In the wiring line 100 of FIG. 14, the first electrically-conductive portion 102 and the second electrically-conductive portion 103 are wired by twisted wiring at a portion covered by the protective layer 104. By wiring the first electrically-conductive portion 102 and the second electrically-conductive portion 103 by the twisted wiring in this manner, an electromotive force attributed to a magnetic field can be canceled, and electromagnetic noise can be suppressed more reliably. Moreover, providing the wiring line 100 with the shield portion 101 can enhance the electromagnetic shield effect for the imaging element 121 at low cost without adding another component for shielding. In the wiring line 100 of FIG. 14, through-holes 106 that each penetrate the shield portion 101 are disposed on both sides of the portion on which the first electrically-conductive portion 102 and the second electrically-conductive portion 103 are wired by the twisted wiring in the shield portion 101. For example, when the through-hole 106 is connected to the second electrically-conductive portion 103 at one point, a current does not flow to the shield portion 101, and thus entry of electromagnetic noise into the circuit of the imaging element 121 can be suppressed more reliably. At portions that are not covered by the protective layer 104 in the wiring line 100 of FIG. 14, the first and second electrically-conductive portions 102 and 103 extend in the extension direction of the wiring line 100, with a predetermined interval made therebetween in the width direction orthogonal to the extension direction of the wiring line 100. In FIG. 14, the configuration other than the shield portion 101, the first electrically-conductive portion 102, and the second electrically-conductive portion 103 is omitted.

In the wiring line 100 of FIG. 15, the first electrically-conductive portion 102 and the second electrically-conductive portion 103 are not wired by twisted wiring at the portion covered by the protective layer 104. That is, also at the portion covered by the protective layer 104, the first electrically-conductive portion 102 and the second electrically-conductive portion 103 extend in the extension direction of the wiring line 100, with a predetermined interval made therebetween in the width direction. In the wiring line 100 of FIG. 15, compared with the wiring line 100 of FIG. 14, the number of electrode layers forming the first electrically-conductive portion 102 and the second electrically-conductive portion 103 is smaller by one, and thus the electromagnetic shield effect for the imaging element 121 can be enhanced at lower cost.

By combining, as appropriate, any embodiments or modifications among the above-described various embodiments or modifications, effects that each embodiment or modification has can be provided. Further, a combination between embodiments, or a combination between examples, or a combination between an embodiment and an example is possible. In addition, a combination between features in different embodiments or examples is also possible.

Although the present disclosure has been described in each embodiment with a certain level of detailedness, the content of the disclosure of these embodiments should change in a detail of a configuration, and a change in a combination or order of elements in each embodiment can be implemented without departing from the scope and spirit of the present disclosure claimed.

### REFERENCE SIGNS LIST

1 vibration device
3 external vibration body
5 lens
7 internal vibration body
9 piezoelectric element
10 vibration body
11 inner layer lens
21 fixing portion
22 inner layer lens barrel
31 first connection portion
33 attenuator portion
35 fixing portion
41 second connection portion
42 non-axisymmetric portion
43 gap
51 flat surface portion
52 concave portion
60 attenuator portion
71 first portion
72 second portion
73 third portion
80 casing
81 opening end
82 imaging portion
83 substrate
100 wiring line
311 plate-shaped portion
312 protrusion
331, 421 first attenuator portion
332, 422 second attenuator portion
423 inclined surface

1. A vibration device comprising:
an internal vibration body constructed to amplify vibration;
a piezoelectric element connected to a first end of the internal vibration body in a first direction and constructed to generate vibration;
a light transmissive body connected to a second end of the internal vibration body in the first direction and has an optical axis extending in the first direction; and
an external vibration body including a first connection portion connected to the light transmissive body and an attenuator portion that extends in a second direction intersecting the first direction from the first connection portion toward an outside of the light transmissive body and constructed to attenuate vibration, wherein
the attenuator portion has non-axisymmetry with respect to the optical axis.

2. The vibration device according to claim 1, wherein the attenuator portion has a first attenuator portion and a second attenuator portion located symmetrically with respect to the optical axis in a sectional view along the optical axis.

3. The vibration device according to claim 2, wherein a dimension of the first attenuator portion in the first direction is different from a dimension of the second attenuator portion in the first direction.

4. The vibration device according to claim 2, wherein a dimension of the first attenuator portion in the second direction is different from a dimension of the second attenuator portion in the second direction.

5. The vibration device according to claim 2, wherein a material of the first attenuator portion is different from a material of the second attenuator portion.

6. The vibration device according to claim 5, wherein the first attenuator portion comprises a material with a higher Young's modulus than a material of the second attenuator portion.

7. The vibration device according to claim 2, wherein the first attenuator portion is located on an upper side in a vertical direction relative to the second attenuator portion.

8. The vibration device according to claim 1, wherein the internal vibration body is located symmetrically with respect to the optical axis.

9. The vibration device according to claim 1, wherein the piezoelectric element is located symmetrically with respect to the optical axis.

10. The vibration device according to claim 2, further comprising a wiring line connected to the piezoelectric element at a position closer to the first attenuator portion than to the second attenuator portion.

11. The vibration device according to claim 10, wherein the wiring line includes a shield portion constructed to suppress electromagnetic noise.

12. The vibration device according to claim 11, wherein the wiring line includes at least two electrically-conductive portions electrically independent of each other.

13. The vibration device according to claim 12, wherein
the at least two electrically-conductive portions have a first electrically-conductive portion connected to the piezoelectric element and constructed to transmit a signal to the piezoelectric element and a second electrically-conductive portion with a fixed potential, and
the second electrically-conductive portion has a same potential as the shield portion.

14. The vibration device according to claim 13, further comprising:
an imaging element located on the optical axis inside the internal vibration body, wherein
the wiring line includes a plurality of layers, and
the shield portion forms one of the plurality of layers and is located closer to the imaging element than the first electrically-conductive portion and the second electrically-conductive portion.

15. The vibration device according to claim 13, wherein the first electrically-conductive portion and the second electrically-conductive portion are wired by twisted wiring.

16. The vibration device according to claim 1, wherein the attenuator portion includes:
a second connection portion that extends in the second direction from the first connection portion toward the outside of the light transmissive body, and
a non-axisymmetric portion that is located closer to the light transmissive body than the second connection portion in the first direction and is connected to the second connection portion, the non-axisymmetric portion having non-axisymmetry with respect to the optical axis.

17. The vibration device according to claim 16, wherein the first attenuator portion is in contact with the second connection portion, and the second attenuator portion is not in contact with the second connection portion such that there is a gap between the second attenuator portion and the second connection portion.

18. The vibration device according to claim 16, wherein both the first attenuator portion and the second attenuator portion are in contact with the second connection portion.

19. The vibration device according to claim 18, wherein the first attenuator portion has a rectangular section, and the second attenuator portion has an inclined surface that inclines toward the second connection portion in the first direction away from the first connection portion in the second direction.

20. A vibration device comprising:
a vibration body constructed to amplify vibration;
a piezoelectric element connected to a first end of the vibration body in a first direction and constructed to generate vibration;
a light transmissive body connected to a second end of the vibration body in the first direction and has an optical axis extending in the first direction; and
an attenuator portion that is located at an edge portion of the light transmissive body in a second direction intersecting the first direction and connects the vibration body to the light transmissive body, the attenuator portion constructed to attenuate vibration, wherein
the attenuator portion has non-axisymmetry with respect to the optical axis.
